(19) United States
(12) Patent Application Publication
(10) Pub. No.: US 2025/0046273 A1
(43) Pub. Date: Feb. 6, 2025

(54) STRING INSTRUMENT AND PICKUP

(71) Applicant: Yamaha Corporation, Hamamatsu (JP)

(72) Inventors: Yuki UEYA, Iwata (JP); Koji YATAKA, Hamamatsu (JP); Ichiro FUTOHASHI, Hamamatsu (JP); Kiyoyuki TOMIMATSU, Hamamatsu (JP)

(21) Appl. No.: 18/926,294

(22) Filed: Oct. 24, 2024

Related U.S. Application Data
(63) Continuation of application No. PCT/JP2023/014896, filed on Apr. 12, 2023.

(30) Foreign Application Priority Data
Apr. 26, 2022 (JP) 2022-072078

(51) Int. Cl. G10D 3/04; G10H 3/18

(52) U.S. Cl. CPC G10D 3/04; G10H 3/181

(57) ABSTRACT

A string instrument includes a saddle inserted into a groove of an instrument main body and supporting strings, and a pickup including a piezoelectric element having a porous layer that is stretchable and compressible, and that outputs a detection signal in accordance with a stretching/compressing deformation of the porous layer. The piezoelectric element is disposed between a first side surface of the saddle and a first inner side surface of the groove. A width of the groove from the first inner side surface to the second inner side surface of the groove is greater than a width of the saddle in an arrangement direction in which the first and the second inner side surfaces are arranged. A thickness of the piezoelectric element under no load in the arrangement direction is greater than or equal to the difference between the width of the groove and the width of the saddle.

### CROSS-REFERENCE TO RELATED APPLICATIONS

This application is a continuation application of International Application No. PCT/JP2023/014896, filed on Apr. 12, 2023, which claims priority to Japanese Patent Application No. 2022-072078 filed in Japan on Apr. 26, 2022. The entire disclosures of International Application No. PCT/JP2023/014896 and Japanese Patent Application No. 2022-072078 are hereby incorporated herein by reference.

### BACKGROUND

### Technical Field

This disclosure relates to a string instrument and a pickup.

### Background Information

Japanese Laid Open Patent Application No. 2007-33806 discloses an invention of a string instrument in which a saddle for supporting strings is fitted into a groove formed on a body, and a piezoelectric element is disposed between a side surface of the saddle and an inner side surface of the groove. In this string instrument, the piezoelectric element outputs an electrical signal (detection signal) on the basis of changes in the pressing force that acts on the piezoelectric element as the strings vibrate.

### SUMMARY

The piezoelectric element disclosed in Japanese Laid Open Patent Application No. 2007-33806 is stiff and has a small amount of expansion/contraction. Therefore, the thickness of the piezoelectric element that is disposed between the side surface of the saddle and the inner side surface of the groove needs to be set with high accuracy with respect to the side surface of the saddle and the inner side surface of the groove. That is, it is difficult to dispose the piezoelectric element between the side surface of the saddle and the inner side surface of the groove without gaps.

In addition, when the gap between the side surface of the saddle and the inner side surface of the groove increases due to changes in the vibrations of the strings or the string tension as a result of the amount of expansion/contraction of the piezoelectric element being small, the piezoelectric element is likely to separate from the side surface of the saddle or the inner side surface of the groove, and may not be able to correctly output the detection signal.

In consideration of the circumstances described above, an object of this disclosure is to provide a pickup and a string instrument in which a piezoelectric element can be easily installed between a side surface of a saddle and an inner side surface of a groove, and with which it is possible to correctly output a detection signal corresponding to movements of the saddle.

A first aspect of this disclosure is a string instrument, comprising: an instrument main body; strings; a saddle that is inserted into a groove formed on the instrument main body and supports the strings; and a pickup that includes at least one piezoelectric element that has a porous layer that is stretchable and compressible in a thickness direction of the porous layer, and that is configured to output a detection signal in accordance with a stretching and compressing deformation of the porous layer. The at least one piezoelectric element is disposed between a first inner side surface of the groove and a first side surface of the saddle. A width of the groove extending from the first inner side surface of the groove to a second inner side surface of the groove that is opposite to the first inner side surface is greater than a width of the saddle in an arrangement direction in which the first inner side surface and the second inner side surface are arranged. A thickness of the at least one piezoelectric element in the arrangement direction under no load is smaller than a difference between the width of the groove and the width of the saddle.

A second aspect of this disclosure is a string instrument, comprising: an instrument main body; strings; a saddle that is inserted into a groove formed on the instrument main body and supports the strings; and a pickup that includes at least one piezoelectric element that has a porous layer that is stretchable and compressible in a thickness direction of the porous layer, and that is configured to output a detection signal in accordance with a stretching and compressing deformation of the porous layer. The at least one piezoelectric element is disposed between a first inner side surface of the groove and a first side surface of the saddle. A width of the groove extending from the first inner side surface of the groove to a second inner side surface of the groove that is opposite to the first inner side surface is greater than a width of the saddle in an arrangement direction in which the first inner side surface and the second inner side surface are arranged. A thickness of the at least one piezoelectric element in the arrangement direction under no load is smaller than a difference between the width of the groove and the width of the saddle.

A third aspect of this disclosure is a pickup, comprising a first piezoelectric element that has a first porous layer that is stretchable and compressible in a thickness direction of the first porous layer, and that is configured to output a detection signal in accordance with a stretching and compressing deformation of the first porous layer. The first piezoelectric element is configured to be disposed between a first inner side surface of a groove formed on an instrument main body of a string instrument, and a first side surface of a saddle of the string instrument, the saddle is inserted into the groove. A width of the groove extending from the first inner side surface of the groove to a second inner side surface of the groove that is opposite to the first inner side surface is greater than a width of the saddle in an arrangement direction in which the first inner side surface and the second inner side surface are arranged. A thickness of the first piezoelectric element in the arrangement direction under no load is greater than or equal to a difference between the width of the groove and the width of the saddle.

A fourth aspect of this disclosure is a pickup, comprising a first piezoelectric element that has a first porous layer that is stretchable and compressible in a thickness direction of the first porous layer, and that is configured to output a detection signal in accordance with a stretching and compressing deformation of the first porous layer. The first piezoelectric element is configured to be disposed between a first inner side surface of a groove formed on an instrument main body of a string instrument, and a first side surface of a saddle of the string instrument, the saddle being inserted into the groove. A width of the groove extending from the first inner side surface of the groove to a second inner side surface of the groove that is opposite to the first inner side surface is greater than a width of the saddle in an arrangement direction in which the first inner side surface and the second inner side surface are arranged. A thickness of the first piezoelectric element in the arrangement direction under no load is smaller than a difference between the width of the groove and the width of the saddle.

### BRIEF DESCRIPTION OF THE DRAWINGS

FIG. 1 is a perspective view showing a string instrument according to a first embodiment of this disclosure.

FIG. 2 is an enlarged cross-sectional view schematically showing a main part of the string instrument of FIG. 1.

FIG. 3 is a cross-sectional view schematically showing a pickup according to the first embodiment of this disclosure.

FIG. 4 is an enlarged cross-sectional view showing a state in which tensile force of strings is not acting on a saddle in the first embodiment of this disclosure.

FIG. 5 is an enlarged cross-sectional view showing a state in which tensile force of the strings is acting on the saddle in the first embodiment of this disclosure.

FIG. 6 is an enlarged cross-sectional view showing a main part of a string instrument according to a second embodiment of this disclosure.

FIG. 7 is a cross-sectional view schematically showing a pickup according to the second embodiment of this disclosure.

FIG. 8 is an enlarged cross-sectional view showing a state in which tensile force of the strings acts on the saddle from the state shown in FIG. 6.

FIG. 9 is an enlarged cross-sectional view of a main part of a string instrument according to a third embodiment of this disclosure, showing a state in which tensile force of the strings is not acting on the saddle.

FIG. 10 is an enlarged cross-sectional view of the main part of the string instrument according to the third embodiment of this disclosure, showing a state in which the tensile force of the strings is acting on the saddle.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### First Embodiment

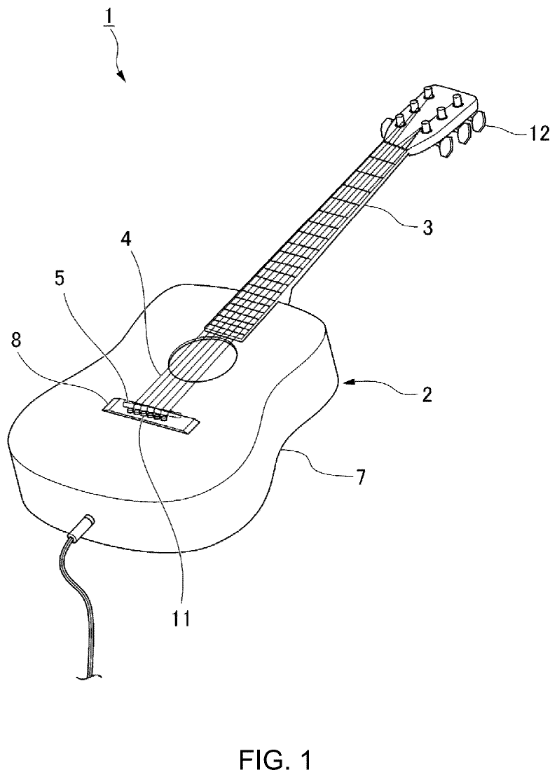

The first embodiment of this disclosure will be described below, with reference to FIGS. 1-5.

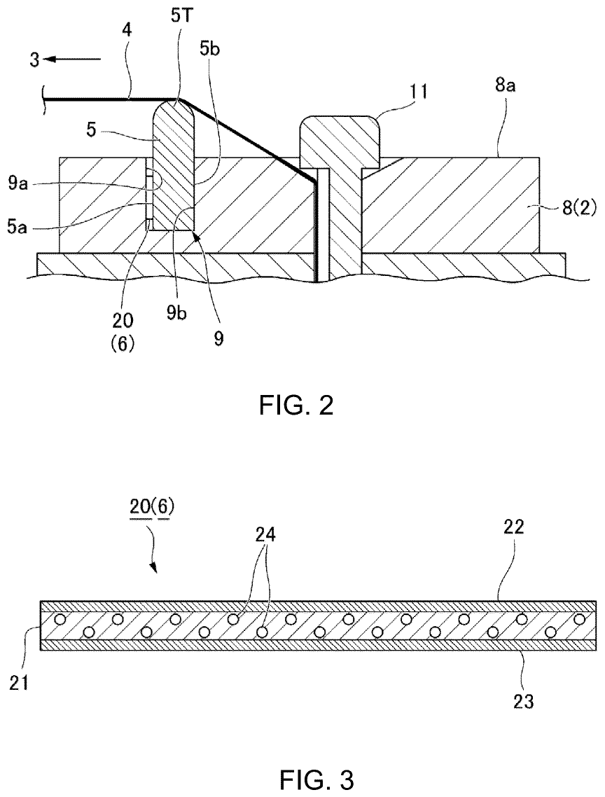

As shown in FIGS. 1 and 2, a string instrument 1 of the first embodiment is a guitar, comprising an instrument main body 2, a neck 3, strings 4, a saddle 5, and a pickup 6.

As shown in FIG. 1, the instrument main body 2 has a body 7, and a bridge 8 provided on the surface of the body 7. The neck 3 extends in one direction from the body 7 of the instrument main body 2. The strings 4 are stretched across the instrument main body 2 and the neck 3. Specifically, first ends of the strings 4 are fixed to string fixing portions 11 provided on the bridge 8. Second ends of the strings 4 are wound by winders 12 provided at the distal end of the neck 3.

As shown in FIG. 2, the saddle 5 is inserted into a groove 9 formed on the bridge 8 of the instrument main body 2. The saddle 5 supports the strings 4 stretched across the instrument main body 2 and the neck 3 in a state of being inserted into the groove 9. Specifically, the groove 9 is formed recessed from a surface 8a of the bridge 8. A portion of the saddle 5 that is inserted into the groove 9 protrudes from the surface 8a of the bridge 8. A distal end portion 5T of the saddle 5 protruding from the surface 8a of the bridge 8 supports the strings 4. The groove 9 of the bridge 8 and the saddle 5 inserted into the groove 9 are positioned between the neck 3 and the string fixing portions 11 in a longitudinal direction of the strings 4 (left-right direction in FIG. 2).

The pickup 6 detects vibrations of the strings 4 stretched across the instrument main body 2 and the neck 3, and outputs a detection signal corresponding to the vibrations of the strings 4. The detection signal is an electrical signal, used for outputting sound from a speaker. The pickup 6 includes a piezoelectric element 20 provided between the saddle 5 and the groove 9 of the instrument main body 2.

As shown in FIG. 3, the piezoelectric element 20 is formed in a plate shape and has a porous layer 21, and electrode layers 22, 23. The piezoelectric element 20 generates voltage in accordance with a stretching and compressing deformation (expansion/contraction deformation) of the porous layer 21 in the thickness direction and outputs an electrical signal (detection signal).

The porous layer 21 is formed in a plate shape and is stretchable and compressible (can elastically expand and contract) in the thickness direction. The porous layer 21 has a plurality of pores 24 therein. As a result, the piezoelectric element 20 that includes the porous layer 21 can stretch and compress more readily than a piezoelectric element with no porous layer.

The main component that forms the porous layer 21 is preferably able to take a charge, such as polypropylene (PP), polyethylene (PE), polyethylene terephthalate (PET), polyvinyl chloride, and polyolefin-based and fluorine-based resins. The “main component” refers to the component of highest content, for example, the component with a content of 50 mass % or more.

The porous layer 21 is generally formed by applying a polarization treatment on a plate-shaped body that mainly includes such a synthetic resin. Examples of polarization treatment methods include a method in which a DC (direct current) or a pulsed high voltage is applied to inject charge; a method in which ionizing radiation, such as y rays or electron beams, is irradiated to inject charge; and a method in which a corona discharge treatment is used to inject charge.

The electrode layers 22, 23 are laminated on both sides of the porous layer 21 in the thickness direction. These two electrode layers 22, 23 are respectively connected to lead wires, which are not shown. The material forming the electrode layers 22, 23 can be any conductive material, such as various metals such as aluminum and silver, alloys thereof, and carbon.

The method of laminating the electrode layers 22, 23 onto the porous layer 21 is not particularly limited, and examples include aluminum deposition, printing of carbon conductive ink, and coating and drying of silver paste.

As shown in FIG. 2, the piezoelectric element 20 (first piezoelectric element) is disposed between a first inner side surface 9a of the groove 9 and a first side surface 5a of the saddle 5.

The first inner side surface 9a of the groove 9 and the first side surface 5a of the saddle 5 face each other in the longitudinal direction of the strings 4, which are supported by the saddle 5, in a state in which the saddle 5 is inserted into the groove 9. In addition, the first inner side surface 9a of the groove 9 and the first side surface 5a of the saddle 5 are located on the neck 3 side in the longitudinal direction of the strings 4. On the other hand, a second inner side surface 9b of the groove 9 that opposes the first inner side surface 9a of the groove 9 in the longitudinal direction of the strings 4 is located on the string fixing portions 11 side in the longitudinal direction of the strings 4. A second side surface 5b of the saddle 5 that faces the opposite side as the first side surface 5a, the saddle 5 being inserted into the groove 9, faces the second inner side surface 9b of the groove 9.

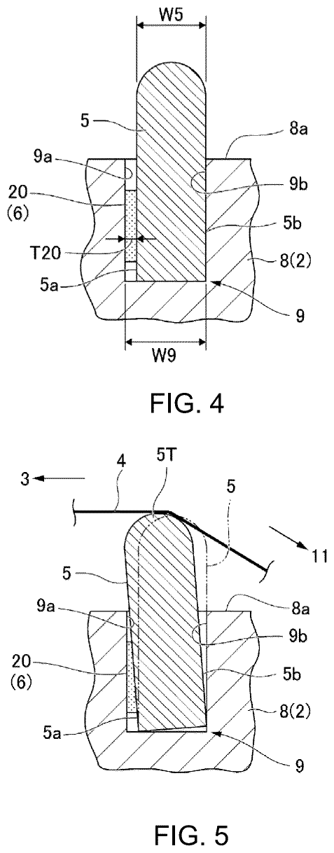

As shown in FIG. 4, a width W9 of the groove 9 from the first inner side surface 9a to the second inner side surface 9b is greater than a width W5 of the saddle 5 from the first side surface 5a to the second side surface 5b. For this reason, in a state in which the saddle 5 is inserted into the groove 9 such that the second side surface 5b of the saddle 5 is in contact with the second inner side surface 9b of the groove 9, a gap is formed between the first inner side surface 9a of the groove 9 and the first side surface 5a of the saddle 5.

The piezoelectric element 20 is disposed between the first inner side surface 9a and the first side surface 5a such that the thickness direction thereof is oriented in an arrangement direction in which the first inner side surface 9a of the groove 9 and the first side surface 5a of the saddle 5 are arranged. In the present embodiment, a thickness T20 of the piezoelectric element 20 under no load is equal to the difference between the width W9 of the groove 9 and the width W5 of the saddle 5. The piezoelectric element 20 under no load means a state in which an external force is not acting on the piezoelectric element 20, and the piezoelectric element 20 is not elastically stretched and compressed. Therefore, in a state in which the piezoelectric element 20 is simply disposed between the first inner side surface 9a of the groove 9 and the first side surface 5a of the saddle 5, the piezoelectric element 20 is not compressed in the thickness direction but is in contact with the first inner side surface 9a and the first side surface 5a. In this state, the saddle 5 can move only in the direction approaching the first inner side surface 9a of the groove 9, and not in the direction away from the first inner side surface 9a of the groove 9. Therefore, the contact between the piezoelectric element 20 and the first inner side surface 9a of the groove 9, and the contact between the piezoelectric element 20 and the first side surface 5a of the saddle 5 are maintained.

In a state in which the saddle 5 and the piezoelectric element 20 are disposed in the groove 9, as described above, when the strings 4 stretched across the string fixing portions 11 of the instrument main body 2 and the neck 3 are supported by the distal end portion 5T of the saddle 5, as shown in FIG. 5, an external force based on the tensile force of the strings 4 acts on the saddle 5. Specifically, the strings 4 stretched across the string fixing portions 11 of the instrument main body 2 and the neck 3 press the distal end portion 5T of the saddle 5 toward the neck 3. As a result, the saddle 5 moves so as to tilt toward the first inner side surface 9a of the groove 9, and, as a result, the piezoelectric element 20 is compressed in the thickness direction thereof. In this state, a gap forms between the second inner side surface 9b of the groove 9 and the second side surface 5b of the saddle 5.

The thickness of the piezoelectric element 20 compressed in the manner described above can be, for example, 50% or more, but more preferably 70% or more, for example, of the thickness T20 of the piezoelectric element 20 under no load. That is, the amount of compression of the piezoelectric element 20 due to external force is preferably small. This is because the sensitivity of the piezoelectric element 20 increases as the compression amount of the piezoelectric element 20 decreases.

In the string instrument 1 of the present embodiment configured in the manner described above, vibrations of the strings 4 are transmitted to the piezoelectric element 20 via the saddle 5, and the porous layer 21 of the piezoelectric element 20 stretches and compresses in the thickness direction thereof. As a result, the piezoelectric element 20 outputs a detection signal (electrical signal) corresponding to the stretching and compressing deformation of the porous layer 21.

As described above, in the pickup 6 and the string instrument 1 of the present embodiment, the piezoelectric element 20 has the porous layer 21. The piezoelectric element 20 stretches and compresses more readily than a piezoelectric element that does not include the porous layer 21 (such as a conventional piezoelectric element). As a result, it is possible to install the piezoelectric element 20 between the first inner side surface 9a of the groove 9 and the first side surface 5a of the saddle 5 without any gaps therebetween by causing the piezoelectric element 20 to stretch or compress in the thickness direction thereof, without needing to set the thickness T20 of the piezoelectric element 20 under no load with high accuracy with respect to the gap between the first inner side surface 9a of the groove 9 and the first side surface 5a of the saddle 5 as in the prior art. That is, even if the dimensional accuracy of the piezoelectric element 20 is low, the piezoelectric element 20 can be easily installed between the first inner side surface 9a of the groove 9 and the first side surface 5a of the saddle 5.

In addition, since the amount of stretching and compressing of the piezoelectric element 20 is large, it is possible to make the piezoelectric element 20 less likely to separate from the first inner side surface 9a of the groove 9 and the first side surface 5a of the saddle 5, even if the gap between the first inner side surface 9a of the groove 9 and the first side surface 5a of the saddle 5 increases due to string vibration, or the like. It is thereby possible to cause the piezoelectric element 20 installed between the saddle 5 and the groove 9 to stretch and compress in accordance with the movement of the saddle 5, and, as a result, it is possible to correctly output a detection signal from the piezoelectric element 20.

Furthermore, in the pickup 6 and the string instrument 1 of the present embodiment, the width W9 of the groove 9 from the first inner side surface 9a to the second inner side surface 9b is greater than width W5 of the saddle 5 from the first side surface 5a to the second side surface 5b. In addition, the thickness T20 of the piezoelectric element 20 under no load, the piezoelectric element 20 being disposed between the first inner side surface 9a of the groove 9 and the first side surface 5a of the saddle 5, is equal to the difference between the width W9 of the groove 9 and the width W5 of the saddle 5. For this reason, even if the saddle 5 moves in the direction in which the first side surface 5a of the saddle 5 and the first inner side surface 9a of the groove 9 are arranged, the piezoelectric element 20 does not separate from the first side surface 5a of the saddle 5 and the first inner side surface 9a of the groove 9. It is thereby possible to cause the piezoelectric element 20 to stretch and compress in accordance with the movement of the saddle 5 without bonding the piezoelectric element 20 to the saddle 5 or the groove 9, and, as a result, it is possible to correctly output a detection signal from the piezoelectric element 20. That is, it is possible to correctly output a detection signal from the pickup 6 in accordance with the movement of the saddle 5, while eliminating the need to bond the piezoelectric element 20 to the saddle 5 or the groove 9.

In addition, because it is not necessary to bond the piezoelectric element 20 to the saddle 5 or the groove 9, the saddle 5 can be easily replaced or adjusted.

Additionally, in the pickup 6 and the string instrument 1 of the present embodiment, the piezoelectric element 20 is disposed between the first inner side surface 9a of the groove 9 and the first side surface 5a of the saddle 5, in a state in which the porous layer 21 is compressed in the thickness direction by the tensile force of the strings 4, as shown in FIG. 5. In this state, when the saddle 5 shifts in a direction approaching the first inner side surface 9a of the groove 9 by vibration of the strings 4, the porous layer 21 of the piezoelectric element 20 is further compressed. In addition, when the saddle 5 shifts in a direction away from the first inner side surface 9a of the groove 9, the porous layer 21 of the piezoelectric element 20 stretches. As a result, the piezoelectric element 20 is able to detect shifts of the saddle 5 in the directions approaching and moving away from the first inner side surface 9a of the groove 9.

In the first embodiment, the thickness T20 of the piezoelectric element 20 under no load can be greater than the difference between the width W9 of the groove 9 and the width W5 of the saddle 5, for example. In this case, the piezoelectric element 20 is disposed between the first inner side surface 9a and the first side surface 5a, in a state in which the porous layer 21 is compressed in the thickness direction thereof. Even with such a configuration, the piezoelectric element 20 is able to detect shifts of the saddle 5 in the directions approaching and moving away from the first inner side surface 9a of the groove 9, in the same manner as in the first embodiment described above.

In the first embodiment, the piezoelectric element 20 can be bonded to the first side surface 5a of the saddle 5 and the first inner side surface 9a of the groove 9, for example. In this case, the piezoelectric element 20 can detect shifts of the saddle 5 even if the piezoelectric element 20 stretches relative to the no-load state, when the saddle 5 shifts in the direction away from the first inner side surface 9a of the groove 9 in accordance with the string vibrations.

### Second Embodiment

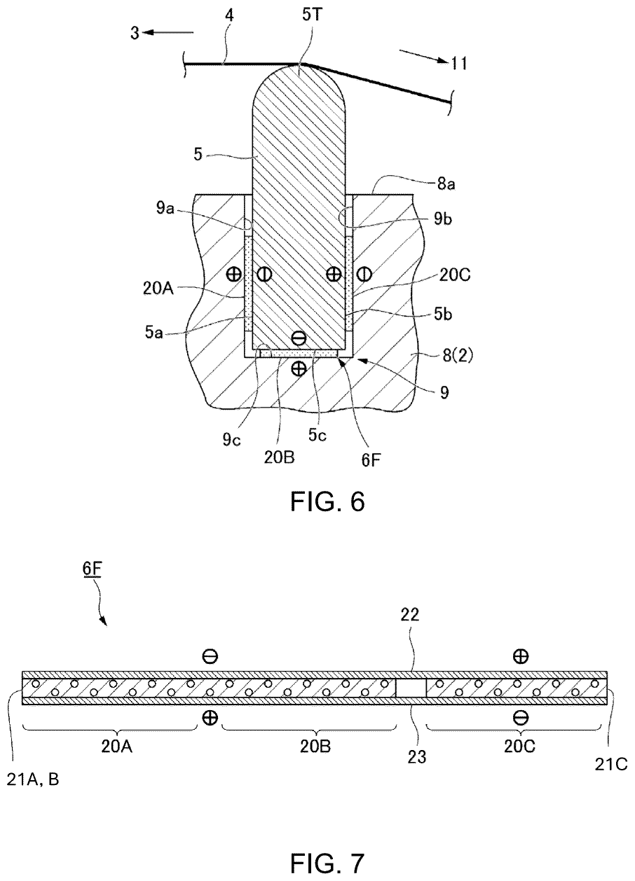

The second embodiment of this disclosure will be described next with reference to FIGS. 6-8. In the following description, the configurations that are the same as those already explained have been assigned the same reference numerals and redundant descriptions have been omitted.

As shown in FIG. 6, in the string instrument of the second embodiment, the saddle 5, which is inserted into the groove 9 of the bridge 8, supports the strings 4 stretched across the string fixing portions 11 of the instrument main body 2 and the neck 3, in the same manner as in the first embodiment. The relationship between the width W9 of the groove 9 and the width W5 of the saddle 5 is the same as in the first embodiment (refer to FIG. 4).

A pickup 6F of the second embodiment has three piezoelectric elements 20A, 20B, 20C. The three piezoelectric elements 20A, 20B, 20C include a first piezoelectric element 20A, a second piezoelectric element 20B, and a third piezoelectric element 20C. As shown in FIG. 7, each of the piezoelectric elements 20A, 20B, 20C has the same porous layer 21 (first porous layer 21A, second porous layer 21B, and third porous layer 21C) and electrode layers 22, 23 as in the first embodiment.

As shown in FIG. 6, the first piezoelectric element 20A is disposed between the first inner side surface 9a of the groove 9 and the first side surface 5a of the saddle 5, in the same manner as the piezoelectric element 20 of the first embodiment. The thickness direction of the first piezoelectric element 20A is oriented in the arrangement direction in which the first side surface 5a of the saddle 5 and the first inner side surface 9a of the groove 9 are arranged.

The second piezoelectric element 20B is disposed between a bottom surface 9c of the groove 9 and a lower surface 5c of the saddle 5. The thickness direction of the second piezoelectric element 20B is oriented in an arrangement direction in which the bottom surface 9c of the groove 9 and the lower surface 5c of the saddle 5 are arranged. The bottom surface 9c of the groove 9 and the lower surface 5c of the saddle 5 are aligned in the direction in which the saddle 5 is inserted into and removed from the groove 9 (up-down direction in FIG. 6).

The third piezoelectric element 20C is disposed between the second inner side surface 9b of the groove 9 and the second side surface 5b of the saddle 5. The thickness direction of the third piezoelectric element 20C is oriented in an arrangement direction in which the second inner side surface 9b of the groove 9 and the second side surface 5b of the saddle 5 are arranged. The thickness direction of the third piezoelectric element 20C can completely match the thickness direction of the first piezoelectric element 20A, or be slightly misaligned with the thickness direction of the first piezoelectric element 20A.

In a state in which the three piezoelectric elements 20A, 20B, 20C are disposed between the groove 9 and the saddle 5, the porous layers 21 (21A, 21C) (refer to FIG. 7) of the first piezoelectric element 20A and the third piezoelectric element 20C are preferably compressed in the respective thickness directions. The degree to which the first piezoelectric element 20A and the third piezoelectric element 20C are compressed is preferably set so as to satisfy the following three conditions. The first condition is that, in a state in which external force, such as the tensile force of the strings 4, is not acting on the saddle 5, the first piezoelectric element 20A and the third piezoelectric element 20C are not maximally compressed. The second condition is that, even in state in which the saddle 5 is brought close to the first inner side surface 9a of the groove 9 and the first piezoelectric element 20A is maximally compressed, the contact between the third piezoelectric element 20C and the second inner side surface 9b of the groove 9, and the contact between the third piezoelectric element 20C and the second side surface 5b of the saddle 5 are maintained. The third condition is that, even in state in which the saddle 5 is brought close to the second inner side surface 9b of the groove 9 and the second piezoelectric element 20B is maximally compressed, the contact between the first piezoelectric element 20A and the first inner side surface 9a of the groove 9, and the contact between the first piezoelectric element 20A and the first side surface 5a of the saddle 5 are maintained.

The porous layer 21 (21B) of the second piezoelectric element 20B disposed between the groove 9 and the saddle 5 should be compressed in the thickness direction of the porous layer 21 (21B) by the force that the saddle 5 receives from the strings 4, in a state in which at least the strings 4 stretched across the string fixing portions 11 of the instrument main body 2 and the neck 3 are supported by the distal end portion 5T of the saddle 5. That is, it is not necessary for the porous layer 21 (21B) of the second piezoelectric element 20B to be compressed when an external force is not acting on the saddle 5.

As shown in FIGS. 6 and 7, in the pickup 6F of the present embodiment, the direction of polarization of the porous layer 21 (21C) of the third piezoelectric element 20C is opposite to the direction of polarization of the porous layer 21 of the first piezoelectric element 20A. In addition, the direction of polarization of the porous layer 21 (21B) of the second piezoelectric element 20B is the same as the direction of polarization of the pores in the first piezoelectric element 20A. In the present embodiment, in the porous layers 21 (21A, 21B) of the first piezoelectric element 20A and the second piezoelectric element 20B, the groove 9 side is the positive electrode and the saddle 5 side is the negative electrode. On the other hand, in the porous layer 21 (21C) of the third piezoelectric element 20C, the groove 9 side is the negative electrode and the saddle 5 side is the positive electrode.

When the porous layer 21 is compressed in the thickness direction thereof, current flows in the porous layer 21 from the positive electrode to the negative electrode. In addition, when the porous layer 21 expands in the thickness direction thereof, current flows from the negative electrode to the positive electrode.

As shown in FIG. 7, in the present embodiment, the first piezoelectric element 20A, the second piezoelectric element 20B, and the third piezoelectric element 20C are integrally formed. Specifically, the porous layers 21 (21A, 21B) of the first piezoelectric element 20A and the second piezoelectric element 20B, having the same direction of polarization, are integrally formed. On the other hand, the porous layer 21 (21C) of the third piezoelectric element 20C, which has a direction of polarization that is different from that of the first and second piezoelectric elements 20A, 20B, is formed separately from the porous layers 21 (21A, 21B) of the first and second piezoelectric elements 20A, 20B.

The first and second piezoelectric elements 20A, 20B and the third piezoelectric element 20C are integrally formed by the two electrode layers 22, 23 laminated on both sides of the porous layers 21. Of the two electrode layers 22, 23, the first electrode layer 22 is connected to the negative electrodes of the porous layers 21 (21A, 21B) of the first and second piezoelectric elements 20A, 20B and to the positive electrode of the third piezoelectric element 20C. Of the two electrode layers 22, 23, the second electrode layer 23 is connected to the positive electrodes of the porous layers 21 (21A, 21B) of the first and second piezoelectric elements 20A, 20B and to the negative electrode of the third piezoelectric element 20C.

The pickup 6F and the string instrument 1 of the second embodiment exhibit the same effects as those of the first embodiment.

In addition, in the pickup 6F and the string instrument 1 of the second embodiment, the direction of polarization of the porous layer 21 (21C) of the third piezoelectric element 20C is opposite to the direction of polarization of the porous layer 21 (21A) of the first piezoelectric element 20A. Therefore, even if the electrode layers 22, 23 provided on both sides of the porous layer 21 (21A) of the first piezoelectric element 20A and the electrode layers 22, 23 provided on both sides of the porous layer 21 (21C) of the third piezoelectric element 20C are integrally formed, it is possible to prevent the detection signal output from the first piezoelectric element 20A and the detection signal output from the third piezoelectric element 20C from canceling each other out in accordance with the movement of the saddle 5. In addition, the detection signals output from the first piezoelectric element 20A and the third piezoelectric element 20C are added together in accordance with the movement of the saddle 5. This point will be described below.

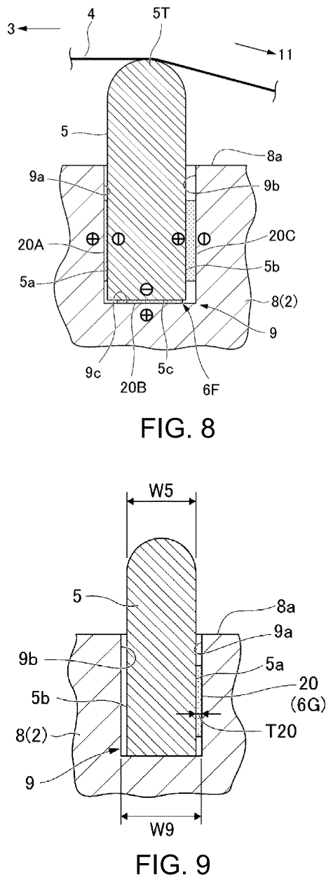

When the vibration of the strings 4 is transmitted to the saddle 5, the saddle 5 vibrates in the longitudinal direction of the strings 4 (arrangement direction in which the first and second inner side surfaces 9a, 9b of the groove 9 are arranged). When the saddle 5 vibrates in this manner, when the first piezoelectric element 20A is compressed, the third piezoelectric element 20C stretches, as shown in FIG. 8. When the first piezoelectric element 20A stretches, the third piezoelectric element 20C is compressed.

In contrast, as shown in FIG. 7, the first electrode layer 22 is connected to the negative electrode of the porous layer 21 (21A) of the first piezoelectric element 20A and the positive electrode of the porous layer 21 (21C) of the third piezoelectric element 20C. On the other hand, the second electrode layer 23 is connected to the positive electrode of the porous layer 21 (21A) of the first piezoelectric element 20A and the negative electrode of the porous layer 21 (21C) of the third piezoelectric element 20C. For this reason, when the first piezoelectric element 20A is compressed and the third piezoelectric element 20C stretches, current flows from the second electrode layer 23 to the first electrode layer 22 in both the first and third piezoelectric elements 20A, 20C. In addition, when the first piezoelectric element 20A stretches and the third piezoelectric element 20C is compressed, current flows from the first electrode layer 22 to the second electrode layer 23 in both the first and third piezoelectric elements 20A, 20C. As a result, the detection signals output from the first and third piezoelectric elements 20A, 20C are added together.

As a result of the detection signals output from the first and third piezoelectric elements 20A, 20C being added together, it is possible to further increase the S/N ratio (signal-to-noise ratio) of the detection signal that is output from the piezoelectric element 20 as the saddle 5 moves.

In addition, in the pickup 6F and the string instrument 1 of the second embodiment, the direction of polarization of the porous layer 21 (21B) of the second piezoelectric element 20B is the same as the direction of polarization of the porous layer 21 (21A) of the first piezoelectric element 20A. Therefore, it is possible to add together the detection signals output from the first and second piezoelectric elements 20A, 20B as the first and second piezoelectric elements 20A, 20B are compressed. This point will be described below.

When playing the string instrument 1, for example, when the strings 4 are pressed against the neck 3 with fingers, the strings 4 are pulled toward the neck 3. In this case, as shown in FIG. 8, the saddle 5 receives force from the strings 4 and moves toward the bottom surface 9c and the first inner side surface 9a of the groove 9. As a result, the first and second piezoelectric elements 20A, 20B, which are located between the groove 9 and the lower surface 5c as well as the first side surface 5a of the saddle 5, are both compressed. Here, since the directions of polarization of the porous layers 21 (21A, 21B) of the first and second piezoelectric elements 20A, 20B are the same, it is possible to add together the detection signals output from the first and second piezoelectric elements 20A, 20B as the first and second piezoelectric elements 20A, 20B are compressed.

As a result of the detection signals output from the first and second piezoelectric elements 20A, 20B being added together, it is possible to further increase the S/N ratio of the detection signal that is output from the piezoelectric element 20 as the saddle 5 moves.

In addition, in the pickup 6F the second embodiment, the first piezoelectric element 20A, the second piezoelectric element 20B, and the third piezoelectric element 20C are integrally formed. Therefore, compared to a case in which these three piezoelectric elements 20A, 20B, 20C are separately formed, the pickup 6F including these three piezoelectric elements 20 can be easily installed between the groove 9 and the saddle 5.

### Third Embodiment

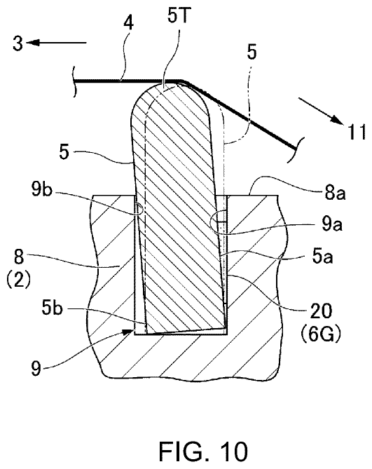

The third embodiment of this disclosure will be described next with reference to FIGS. 9, 10. In the following description, the configurations that are the same as those already explained have been assigned the same reference numerals and redundant descriptions have been omitted.

As shown in FIGS. 9 and 10, in the string instrument 1 of the third embodiment, the saddle 5 is inserted into the groove 9 of the bridge 8 in the same manner as in the first embodiment. The saddle 5 supports the strings 4 stretched across the string fixing portions 11 of the instrument main body 2 and the neck 3. The relationship between the width W9 of the groove 9 and the width W5 of the saddle 5 is the same as in the first embodiment.

A pickup 6G of the third embodiment comprises the same piezoelectric element 20 (first piezoelectric element) as in the first embodiment. In addition, the piezoelectric element 20 is disposed between the first inner side surface 9a of the groove 9 and the first side surface 5a of the saddle 5 such that the thickness direction thereof is oriented in the arrangement direction in which the first side surface 5a of the saddle 5 and the first inner side surface 9a of the groove 9 are arranged.

However, in the third embodiment, the first side surface 5a of the saddle 5 and the first inner side surface 9a of the groove 9 are located on the string fixing portions 11 side in the longitudinal direction of the strings 4. On the other hand, the second inner side surface 9b of the groove 9 and the second side surface 5b of the saddle 5 are located on the neck 3 side in the longitudinal direction of the strings 4.

In addition, the thickness T20 of the piezoelectric element 20 under no load is smaller than the difference between the width W9 of the groove 9 and the width W5 of the saddle 5. The piezoelectric element 20 is bonded to the first side surface 5a of the saddle 5 and to the first inner side surface 9a of the groove 9. Therefore, as shown in FIG. 9, in a state in which the piezoelectric element 20 is simply disposed between the first inner side surface 9a of the groove 9 and the first side surface 5a of the saddle 5, the saddle 5 can move in a direction approaching the first inner side surface 9a as well as in a direction away from the first inner side surface 9a of the groove 9. As a result of the saddle 5 moving in this manner, the piezoelectric element 20 stretches and compresses in the thickness direction thereof.

As described above, in a state in which the saddle 5 and the piezoelectric element 20 are disposed in the groove 9, if the strings 4 stretched across the string fixing portions 11 of the instrument main body 2 and the neck 3 are supported by the distal end portion 5T of the saddle 5, as shown in FIG. 10, the distal end portion 5T of the saddle 5 is pressed toward the neck 3 side by the tensile force of the strings 4. As a result, the saddle 5 moves so as to tilt toward the second inner side surface 9b of the groove 9, and the first side surface 5a of the saddle 5 moves away from the first inner side surface 9a of the groove 9. As a result, the piezoelectric element 20 stretches in the thickness direction thereof.

The thickness of the piezoelectric element 20 stretched as described above can be less than or equal to 150%, but, for example, is more preferably less than or equal to 130% of the thickness T20 of the piezoelectric element 20 under no load. That is, the amount of expansion of the piezoelectric element 20 due to external force is preferably small. This is because the sensitivity of the piezoelectric element 20 increases as the expansion amount of the piezoelectric element 20 decreases.

In the string instrument 1 of the third embodiment configured in the manner described above, the vibration of the strings 4 is transmitted to the piezoelectric element 20 via the saddle 5, and the porous layer 21 of the piezoelectric element 20 stretches and compresses in the thickness direction thereof. As a result, the piezoelectric element 20 outputs a detection signal (electrical signal) corresponding to the stretching and compressing deformation of the porous layer 21. When the piezoelectric element 20 stretches or compresses in a state of being stretched in accordance with string vibrations, the piezoelectric element 20 can stretch or compress relative to the no-load state.

The third embodiment exhibits the same effects as those of the first embodiment.

That is, in the pickup 6G and the string instrument 1 of the third embodiment, the piezoelectric element 20 also stretches and compresses more readily than a piezoelectric element that does not include the porous layer 21 (such as a conventional piezoelectric element). As a result, it is possible to install the piezoelectric element 20 between the first inner side surface 9a of the groove 9 and the first side surface 5a of the saddle 5 without any gaps therebetween, by causing the piezoelectric element 20 to stretch or compress in the thickness direction thereof, without needing to set the thickness T20 of the piezoelectric element 20 under no load with high accuracy with respect to the gap between the first inner side surface 9a of the groove 9 and the first side surface 5a of the saddle 5 as in the prior art. In the third embodiment, the piezoelectric element 20 is bonded to the first inner side surface 9a of the groove 9 and the first side surface 5a of the saddle 5, thereby making it possible to easily dispose the piezoelectric element 20 between the first inner side surface 9a of the groove 9 and the first side surface 5a of the saddle 5 with no gaps therebetween.

In addition, since the amount of stretching and compressing of the piezoelectric element 20 is large, it is possible to suppress or prevent the piezoelectric element 20 from separating from the first inner side surface 9a of the groove 9 and the first side surface 5a of the saddle 5, even if the gap between the first inner side surface 9a of the groove 9 and the first side surface 5a of the saddle 5 increases due to string vibration, or the like. It is thereby possible to cause the piezoelectric element 20 installed between the saddle 5 and the groove 9 to stretch and compress in accordance with the movement of the saddle 5, and, as a result, it is possible to correctly output a detection signal from the piezoelectric element 20.

Additionally, in the pickup 6G and the string instrument 1 of the third embodiment, the piezoelectric element 20 is disposed between the first inner side surface 9a of the groove 9 and the first side surface 5a of the saddle 5, in a state in which the porous layer 21 is stretched in the thickness direction by the tensile force of the strings 4, as shown in FIG. 10. In this state, when the saddle 5 shifts in a direction approaching the first inner side surface 9a of the groove 9 due to vibration of the strings 4, the porous layer 21 of the piezoelectric element 20 is compressed. In addition, when the saddle 5 shifts in a direction away from the first inner side surface 9a of the groove 9, the porous layer 21 of the piezoelectric element 20 further stretches. As a result, the piezoelectric element 20 is able to detect shifts of the saddle 5 in the directions approaching and moving away from the first inner side surface 9a of the groove 9.

In the third embodiment, the piezoelectric element 20, whose thickness T20 under no load is smaller than the difference between the width W9 of the groove 9 and the width W5 of the saddle 5, can be disposed between the second side surface 5b of the saddle 5 and the second inner side surface 9b of the groove 9 located on the neck 3 side in the longitudinal direction of the strings 4, for example. In this case, the strings 4 are stretched across the string fixing portions 11 of the instrument main body 2 and the neck 3, and the strings 4 are supported by the distal end portion 5T of the saddle 5, so that the distal end portion 5T of the saddle 5 is pressed toward the neck 3 by the tensile force of the strings 4. As a result, the piezoelectric element 20 is compressed between the groove 9 and the saddle 5. Accordingly, it is possible to sandwich the piezoelectric element 20 between the second inner side surface 9b of the groove 9 and the second side surface 5b of the saddle 5 without bonding the piezoelectric element 20 to the groove 9 or the saddle 5.

The piezoelectric element 20 of the third embodiment whose thickness T20 under no load is smaller than the difference between the width W9 of the groove 9 and the width W5 of the saddle 5, can be applied to the three piezoelectric elements 20A, 20B, 20C (in particular, to the first and third piezoelectric elements 20A, 20C) of the second embodiment.

This disclosure was described in detail above, but this disclosure is not limited to the embodiments described above, and can be modified within the scope of the spirit of this disclosure.

The pickup of this disclosure is not limited to being applied to a guitar, and can be applied to any string instrument in which, at least, strings are supported by a saddle inserted into a groove formed on the instrument body.

### Effects of the Invention

According to this disclosure, it is possible to easily install a piezoelectric element between a side surface of a saddle and an inner side surface of a groove, and to correctly output a detection signal corresponding to movements of the saddle with a pickup.

What is claimed is:

1. A string instrument comprising:
an instrument main body;
strings;
a saddle that is inserted into a groove formed on the instrument main body and supports the strings; and
a pickup that includes at least one piezoelectric element that has a porous layer that is stretchable and compressible in a thickness direction of the porous layer, and that is configured to output a detection signal in accordance with a stretching and compressing deformation of the porous layer,
the at least one piezoelectric element being disposed between a first inner side surface of the groove and a first side surface of the saddle,
a width of the groove extending from the first inner side surface of the groove to a second inner side surface of the groove that is opposite to the first inner side surface being greater than a width of the saddle in an arrangement direction in which the first inner side surface and the second inner side surface are arranged, and
a thickness of the at least one piezoelectric element in the arrangement direction under no load being greater than or equal to a difference between the width of the groove and the width of the saddle.

2. A string instrument comprising:
an instrument main body;
strings;
a saddle that is inserted into a groove formed on the instrument main body and supports the strings; and
a pickup that includes at least one piezoelectric element that has a porous layer that is stretchable and compressible in a thickness direction of the porous layer, and that is configured to output a detection signal in accordance with a stretching and compressing deformation of the porous layer,
the at least one piezoelectric element being disposed between a first inner side surface of the groove and a first side surface of the saddle,
a width of the groove extending from the first inner side surface of the groove to a second inner side surface of the groove that is opposite to the first inner side surface being greater than a width of the saddle in an arrangement direction in which the first inner side surface and the second inner side surface are arranged, and
a thickness of the at least one piezoelectric element in the arrangement direction under no load being smaller than a difference between the width of the groove and the width of the saddle.

3. A pickup comprising:
a first piezoelectric element that has a first porous layer that is stretchable and compressible in a thickness direction of the first porous layer, and that is configured to output a detection signal in accordance with a stretching and compressing deformation of the first porous layer,
the first piezoelectric element being configured to be disposed between a first inner side surface of a groove formed on an instrument main body of a string instrument, and a first side surface of a saddle of the string instrument, the saddle being inserted into the groove,
a width of the groove extending from the first inner side surface of the groove to a second inner side surface of the groove that is opposite to the first inner side surface being greater than a width of the saddle in an arrangement direction in which the first inner side surface and the second inner side surface are arranged, and
a thickness of the first piezoelectric element in the arrangement direction under no load being greater than or equal to a difference between the width of the groove and the width of the saddle.

4. A pickup comprising:
a first piezoelectric element that has a first porous layer that is stretchable and compressible in a thickness direction of the first porous layer, and that is configured to output a detection signal in accordance with a stretching and compressing deformation of the first porous layer,
the first piezoelectric element being configured to be disposed between a first inner side surface of a groove formed on an instrument main body of a string instrument, and a first side surface of a saddle of the string instrument, the saddle being inserted into the groove,
a width of the groove extending from the first inner side surface of the groove to a second inner side surface of the groove that is opposite to the first inner side surface being greater than a width of the saddle in an arrangement direction in which the first inner side surface and the second inner side surface are arranged, and
a thickness of the first piezoelectric element in the arrangement direction under no load being smaller than a difference between the width of the groove and the width of the saddle.

5. The pickup according to claim 3, wherein
the first piezoelectric element is disposed between the first inner side surface of the groove and the first side surface of the saddle, in a state in which the first porous layer is compressed in the thickness direction.

6. The pickup according to claim 3, further comprising
a second piezoelectric element that has a second porous layer that is stretchable and compressible in a thickness direction of the second porous layer, that is configured to output a detection signal in accordance with a stretching and compressing deformation of the second porous layer, and that is configured to be disposed between a bottom surface of the groove and a lower surface of the saddle, and
a third piezoelectric element that has a third porous layer that is stretchable and compressible in a thickness direction of the third porous layer, that is configured to output a detection signal in accordance with a stretching and compressing deformation of the third porous layer, and that is configured to be disposed between the second inner side surface of the groove and a second side surface of the saddle.

7. The pickup according to claim 6, wherein
a direction of polarization of the third porous layer in the third piezoelectric element is opposite to a direction of polarization of the first porous layer in the first piezoelectric element.

8. The pickup according to claim 7, wherein
the first side surface of the saddle is a surface located on a neck side of the string instrument,
the second side surface of the saddle is a surface located on an opposite side of the neck and on a side of a string fixing part of the instrument main body, the string fixing part fixing one ends of the strings of the string instrument, and
a direction of polarization of the second porous layer in the second piezoelectric element is the same as the direction of polarization of the first porous layer in the first piezoelectric element.

9. The pickup according to claim 6, wherein
the first piezoelectric element, the second piezoelectric element, and the third piezoelectric element are integrally formed.

10. The pickup according to claim 4, wherein
the first piezoelectric element is disposed between the first inner side surface of the groove and the first side surface of the saddle, in a state in which the first porous layer is compressed in the thickness direction.

11. The pickup according to claim 4, further comprising
a second piezoelectric element that has a second porous layer that is stretchable and compressible in a thickness direction of the second porous layer, that is configured to output a detection signal in accordance with a stretching and compressing deformation of the second porous layer, and that is configured to be disposed between a bottom surface of the groove and a lower surface of the saddle, and
a third piezoelectric element that has a third porous layer that is stretchable and compressible in a thickness direction of the third porous layer, that is configured to output a detection signal in accordance with a stretching and compressing deformation of the third porous layer, and that is configured to be disposed between the second inner side surface of the groove and a second side surface of the saddle.

12. The pickup according to claim 11, wherein
a direction of polarization of the third porous layer in the third piezoelectric element is opposite to a direction of polarization of the first porous layer in the first piezoelectric element.

13. The pickup according to claim 12, wherein
the first side surface of the saddle is a surface located on a neck side of the string instrument,
the second side surface of the saddle is a surface located on an opposite side of the neck and on a side of a string fixing part of the instrument main body, the string fixing part fixing one ends of the strings of the string instrument, and
a direction of polarization of the second porous layer in the second piezoelectric element is the same as the direction of polarization of the first porous layer in the first piezoelectric element.

14. The pickup according to claim 11, wherein
the first piezoelectric element, the second piezoelectric element, and the third piezoelectric element are integrally formed.
